(19) United States
(12) Patent Application Publication
(10) Pub. No.: US 2022/0278312 A1
(43) Pub. Date: Sep. 1, 2022

(54) VANADIUM SELENIDE/CARBON CELLULOSE COMPOSITE AS WELL AS PREPARATION METHOD AND APPLICATION THEREOF

(71) Applicant: GUANGDONG UNIVERSITY OF TECHNOLOGY, GUANGZHOU (CN)

(72) Inventors: Miao HE, GUANGZHOU (CN); Yefeng FENG, GUANGZHOU (CN); Chenhao XU, GUANGZHOU (CN); Kaidan WU, GUANGZHOU (CN); Deping XIONG, GUANGZHOU (CN)

(21) Appl. No.: 17/198,379

(22) Filed: Mar. 11, 2021

(30) Foreign Application Priority Data
Feb. 26, 2021 (CN) 202110218380.6

(51) Int. Cl. H01M 4/36; H01M 4/04; H01M 4/583; H01M 4/58; H01M 10/054; C01B 19/00

(52) U.S. Cl. CPC H01M 4/364; H01M 4/0497; H01M 4/583; H01M 4/581; H01M 10/054; C01B 19/007; C01P 2002/72; C01P 2004/03; C01P 2006/40

(57) ABSTRACT

The disclosure provides a preparation method of a vanadium selenide/carbon cellulose composite, belonging to the technical fields of electrode materials of potassium ion batteries and preparation technologies thereof. Through compounding of carbon, carbon cellulose and vanadium diselenide (VSe₂), a synergistic effect occurs between two components, and carbon cellulose-carbon coating is capable of increasing electron conductivity and potassium ion diffusion rate of a material while inhibiting the agglomeration of vanadium diselenide (VSe₂). Therefore, the prepared vanadium selenide/carbon cellulose composite has excellent electrochemical performance and exhibits outstanding rate performance and cycling stability. The method is simple in process, low in cost, environmentally friendly, and suitable for large-scale industrial production.

### CROSS REFERENCES TO RELATED APPLICATIONS

The present application claims foreign priority of Chinese Patent Application No. 202110218380.6, filed on Feb. 26, 2021 in the State Intellectual Property Office of China, the disclosures of all of which are hereby incorporated by reference.

### TECHNICAL FIELD

The disclosure relates to the technical field of potassium ion battery manufacturing, and particularly to a vanadium selenide/carbon cellulose composite as well as a preparation method and application thereof.

### BACKGROUND OF THE PRESENT INVENTION

Due to high open-circuit voltage, long cyclic service life, high energy density, no memory effect and other advantages, a lithium ion battery is widely applied in the fields of portable digital products, electric automobiles and energy accumulation. However, currently, lithium has low storage amount, expensive price and other defects in nature, which limits further development of the lithium ion battery in the fields of electric automobiles and large-scale energy accumulation. Metal potassium becomes an ideal material replacing lithium due to rich storage amount and low price in nature. To meet the sustainable demand of people on a high-energy-density potassium ion battery, improvement of specific capability and cycling stability of a negative electrode of the potassium ion battery has become an important research direction for potassium ion batteries.

Vanadium diselenide, as a typical graphene-like interlayer transition metal selenide, has attracted much attentions in the fields of tribology, energy sources, electronic devices, photoelectricity and the like because of its unique and excellent electrical property, thermal property, mechanical property and other properties. In recent years, a research about vanadium diselenide as a negative electrode material of a potassium ion battery has also drawn researcher's interests. Vanadium diselenide, as the negative electrode material of the potassium ion battery, has the advantages of moderate potassium-embedded voltage (about 1.3 V), good safety, high specific capability and the like. However, since vanadium diselenide itself is poor in conductivity and easy to restack, it will lose good electric connection and a potassium ion pathway during the cycle to finally lead to rapidly drop in capability during the cycle. In order to well address the problem, construction of a vanadium diselenide composite material is an extremely effective method. Therefore, a composite material formed by vanadium diselenide and amorphous carbon, a composite material formed by vanadium diselenide and a carbon nano tube and a composite material formed by vanadium diselenide and graphene are synthesized in succession and applied to negative electrode materials of potassium ion batteries, and their electrochemical performances are greatly improved. In addition, as vanadium diselenide has great mechanical strength, it is believed that vanadium diselenide is capable of inhibiting the volume expansion of other negative electrode materials in the processes of charging and discharging. Thus, a composite material of vanadium diselenide, a metal negative electrode and transition metal oxides has also attracted attentions from researchers.

### SUMMARY OF PRESENT INVENTION

The technical problem to be solved by the disclosure is to provide a vanadium selenide/carbon cellulose composite as well as a preparation method and application thereof. This method is simple and easy to operate, and effectively improves the electron conductivity of VSe₂ and increases the rate performance of the material while inhibiting the volume expansion and agglomeration of VSe₂ and improving the cycling stability of the material.

The vanadium selenide/carbon cellulose composite of the disclosure is a vanadium selenide/carbon cellulose composite prepared by combination of a hydrothermal method, a freeze drying method and a high-temperature pyrolysis method.

In the carbon cellulose coated VSe₂ composite material, the mass percentage of VSe₂ is 50˜60%, and the mass percentage of carbon cellulose is 40˜50%. The preparation method of the vanadium selenide/carbon cellulose composite comprises the following steps:

1) weighing vanadium dioxide and selenium dioxide, dissolving into water or an organic solvent so as to be prepared into a solution having a concentration of 0.5˜2 mol/L, and stirring for 0.5 h to obtain a taupe solution;

2) adding an organic acid into the salt solution obtained in step 1), and continuing to stir for 0.5 h to obtain a mixed solution;

3) transferring the mixed solution obtained in step 2) into a high-pressure hydrothermal reactor with teflon lining, and carrying out heat preservation for 15˜30 h at 150˜220° C.;

4) cooling the solution obtained in step 3), then repeatedly centrifuging with deionized water and absolute alcohol at a rate of 5000˜10000 r/m, and discarding the solution to obtain a black precipitate;

5) drying the black precipitate obtained in step 4) for 12˜24 h at 50˜120° C. to obtain black powder;

6) weighing 10 g of qualitative filter paper, cutting into pieces to be put in a wall-breaking machine, adding 500˜2000 mL of deionized water, homogenizing for 15˜60 min, and repeating homogenization for three times, so as to obtain a 0.5˜2% carbon cellulose aqueous solution;

7) weighing 1.0 g of black powder obtained in step 5) and 500 mL of solution obtained in step 6), and stirring for 12˜24 h;

8) freezing the mixed solution obtained in step 7) with liquid nitrogen at −100˜−200° C. for 5˜20 min to obtain a yellow green frozen solid;

9) carrying out freeze drying on the frozen solid obtained in step 8) for 48˜96 h in vacuum to obtain fluffy aerogel; and

10) grinding the aerogel obtained in step 9), raising a temperature from 25° C. to 500˜600° C. at a rate of 1˜5° C./min at an inert atmosphere and carrying out heat preservation for 0.5˜2 h, subsequently, raising a temperature to 800° C.˜1000° C. at a rate of 1˜5° C./min and carrying out heat preservation for 0.5˜2 h, and naturally cooling to room temperature to obtain the vanadium selenide/carbon cellulose composite.

In the above method, in step 1), the vanadium oxide is vanadium dioxide, the selenium oxide is selenium dioxide, and the solvent is one of deionized water or N-methylpyrrolidone;

in step 2), the organic acid is formic acid;

in step 3), the heat preservation temperature is preferably controlled to 180˜220° C., and the heat preservation time is preferably controlled to 20˜28 h;

in step 4), the centrifugation rate is preferably controlled to 8000˜10000 r/min;

in step 5), the drying temperature is preferably controlled to 80˜100° C., and the heat preservation time is controlled to 18˜24 h;

in step 6), the concentration of the aqueous solution is preferably controlled to 1%;

in step 7), the stirring time is preferably controlled to 18˜24 h;

in step 8), the freezing temperature is preferably controlled to −160˜−200° C., and the freezing time is preferably controlled to 10˜15 min;

in step 9), the freeze drying time is preferably controlled to 72˜96 h;

in step 10), the inert gas atmosphere is one or more of nitrogen or argon, preferably argon, the temperature rising rate is preferably 5° C./min, a first heat preservation temperature is preferably 500˜600° C., the heat preservation time is preferably 1.5˜2 h, a second heat preservation temperature is preferably 900˜1000° C., and the heat preservation time is preferably 0.5˜1 h.

The carbon cellulose coated VSe₂ composite material is prepared by the above method, and used as a negative electrode of a potassium ion battery, vanadium selenide/carbon cellulose composite.

The vanadium selenide/carbon cellulose composite of the disclosure has excellent rate performance and cycling stability. The carbon fiber and vanadium diselenide components form a synergistic effect, which effectively inhibits agglomeration of vanadium diselenide while increasing electron conductivity and potassium ions diffusion rate, thereby effectively improving the rate performance and cycling stability of the material.

### DESCRIPTION OF THE DRAWINGS

FIG. 1 is an XRD (X-ray diffraction) graph of a vanadium selenide/carbon cellulose composite prepared in example 1 and pure VSe₂ via XRD analysis according to the disclosure.

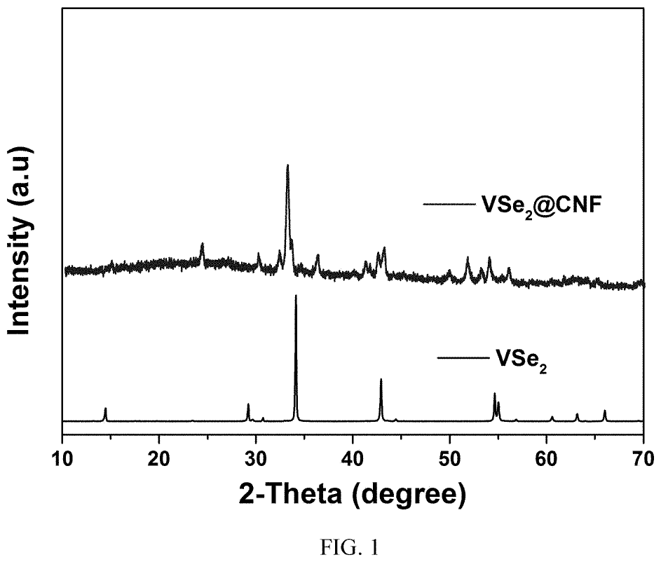

FIG. 2 is an SEM (scanning electron microscope) graph of a vanadium selenide/carbon cellulose composite prepared in example 1 according to the disclosure.

FIG. 3 is an SEM graph of a pure layered VSe₂ material prepared in example 1 according to the disclosure.

FIG. 4 is a graph showing charge-discharge cycle performances of button batteries made of a vanadium selenide/carbon cellulose composite prepared in example 1 and a pure layered VSe₂ material prepared in comparative example 1 respectively under the current density of 100 mAg⁻¹.

FIG. 5 is a graph showing charge-discharge rate performances of button batteries made of a vanadium selenide/carbon cellulose composite prepared in example 1 and a pure layered VSₑ₂ material prepared in comparative example 1 respectively under the current density of 100˜1000 mAg⁻¹.

FIG. 6 is graph showing charge-discharge rate long-cycle performances of a button battery made of a vanadium selenide/carbon cellulose composite prepared in example 1 under the current density of 500 mAg⁻¹.

FIG. 7 is a graph showing charge-discharge cycle performances of a button battery made of a vanadium selenide/carbon cellulose composite prepared in example 2 under the current density of 100 mAg⁻¹.

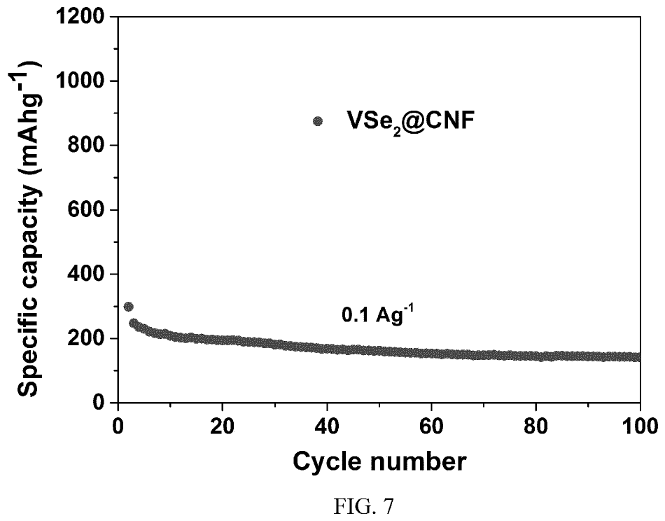

FIG. 8 is a graph showing charge-discharge cycle performances of button batteries made of a vanadium selenide/carbon cellulose composite prepared in example 3 under the current density of 100 mAg⁻¹.

### DETAILED DESCRIPTION OF PREFERRED EMBODIMENTS

The disclosure will be further described by taking the vanadium selenide/carbon cellulose composite as a specific example, but is not limited to these examples.

### Example 1

1, Vanadium dioxide and selenium dioxide were weighed and dissolved into an N-methylpyrrolidone solvent so as to be prepared into a solution having a concentration of 1 mol/L, and the above solution was stirred is for 0.5 h to obtain a taupe solution;

2, formic acid was added into the salt solution obtained in step 1) and continued to be stirred for 0.5 h to obtain a mixed solution;

3, the mixed solution obtained in step 2) was transferred into a high-pressure hydrothermal reactor with teflon lining, and heat preservation was carried out for 24 h at 200° C.;

4, the solution obtained in step 3) was cooled and then repeatedly centrifuged with deionized water and absolute alcohol at a rate of 10000 r/m, and the solution was discarded to obtain a black precipitate;

5, the black precipitate obtained in step 4) was dried for 24 h at 80° C. to obtain black powder;

6, 10 g of qualitative filter paper was weighed and cut into pieces to be put in a wall-breaking machine, 1000 mL of deionized water was added, and homogenization was carried out for 30 min, and homogenization was repeated for three times, so as to obtain a 1% carbon cellulose aqueous solution;

7, 1.0 g of black powder obtained in step 5) and 500 mL of solution obtained in step 6) were weighed, and stirred for 24 h;

8, the mixed solution obtained in step 7) was frozen with liquid nitrogen at −200° C. for 10 min to obtain a yellow green frozen solid;

9, freeze drying was carried out on the frozen solid obtained in step 8) for 96 h in vacuum to obtain fluffy aerogel; and

10, the aerogel obtained in step 9) was ground, a temperature was raised from 25° C. to 500° C. at a rate of 5° C./min at an inert atmosphere and heat preservation was carried out for 1.5 h, subsequently, the temperature was raised to 1000° C. at a rate of 5° C./min and heat preservation was carried out for 0.5 h, and the above aerogel was naturally cooled to room temperature, so as to obtain the vanadium selenide/carbon cellulose composite.

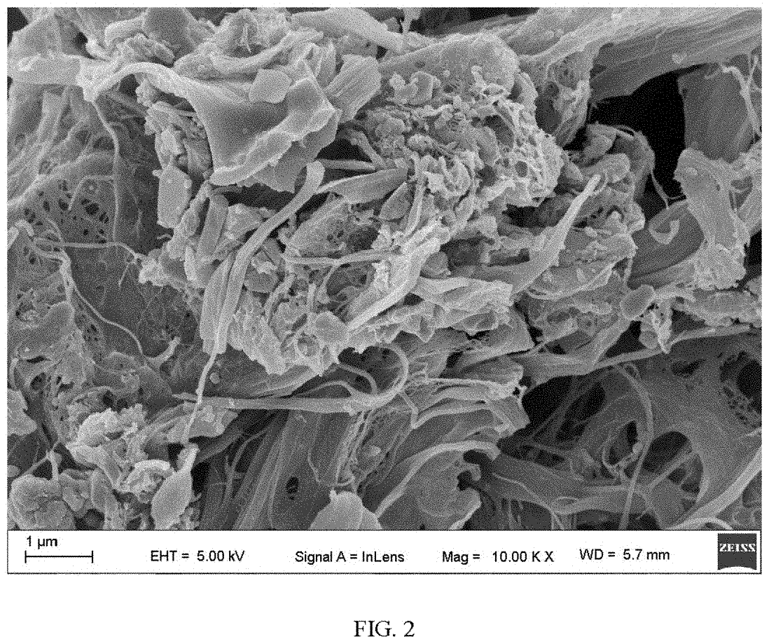

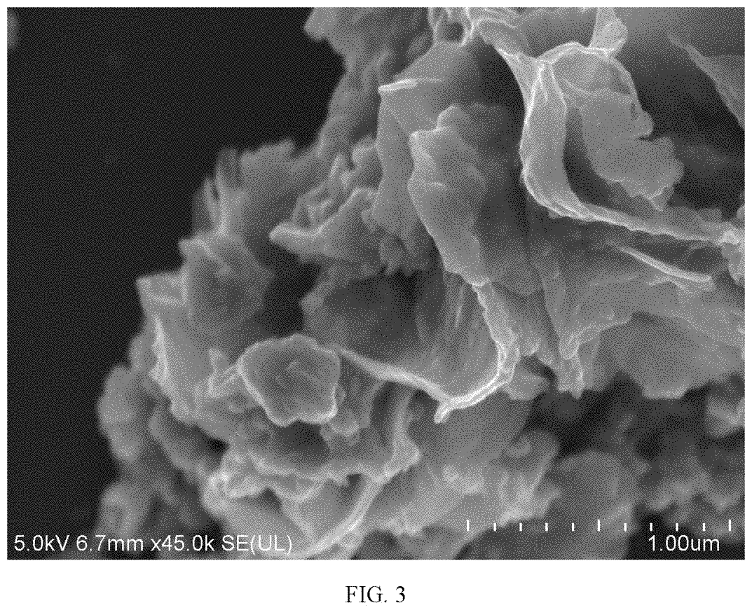

The vanadium selenide/carbon cellulose composite obtained in example 1 and a pure layered VSe₂ material obtained in example 1 were subjected to SEM/TEM analysis. It can be seen from the XRD graph that the vanadium selenide/carbon cellulose composite has the same diffraction peaks as those of the pre-modified layered VSe₂ composite material, indicating that coating with carbon cellulose does not change the phase structure of the layered VSe₂ composite material. The SEM graph of the vanadium selenide/carbon cellulose composite obtained in this example 1 is as shown in FIG. 2, and the SEM graph of the pure layered VSe₂ material used in example 1 is as shown in FIG. 3. By comparing FIG. 2 with FIG. 3, it can be seen that after coating with carbon cellulose, the layered microstructure of the material is unchanged, but its surface is covered with micron or nano fiber belts, which indicates that carbon cellulose has been successfully coated on the VSe₂ material.

The vanadium selenide/carbon cellulose composite obtained in this example 1 in a ratio of 7.5:1.5:1.5, acetylene black and binder PVDF were dissolved into N-methylpyrrolidone and stirred. The obtained slurry is coated on copper foil, and dried in vacuum for 12 h, so as to obtain a positive electrode plate. Then, the battery was assembled in a glove box filled with argon, the positive electrode was the vanadium selenide/carbon cellulose composite, a negative electrode was a potassium plate, a diaphragm was glass fiber, and an electrolyte was KPF₆. The assembled button battery was subjected to electrochemical performance test.

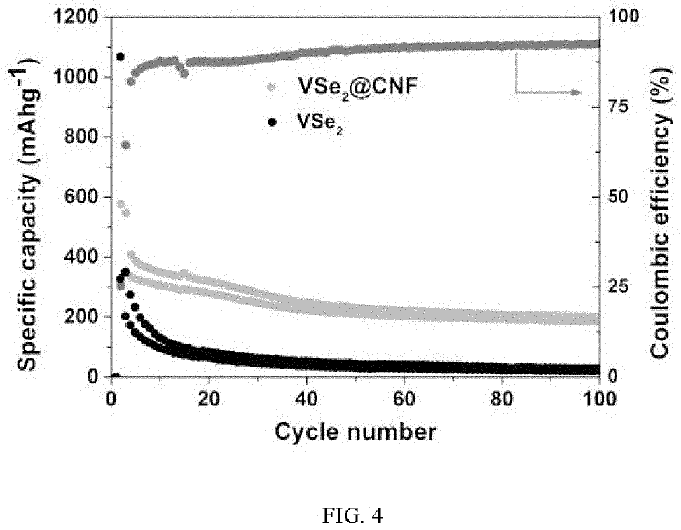

FIG. 4 is a graph showing charge-discharge cycle performances of button batteries made of a vanadium selenide/carbon cellulose composite prepared in example 1 and a pure layered VSe₂ material prepared in comparative example 1 respectively under the current density of 100 mAg⁻¹. It can be seen from FIG. 4 that the vanadium selenide/carbon cellulose composite prepared in example 1 has a capacity of 200 mAhg⁻¹ after 100 cycles, however, the pure layered VSe₂ material only has a capacity of 30.8 mAhg⁻¹ after 100 cycles. According to the above results, the reversible capacity and cycling stability of the material can be effectively improved after VSe₂ is coated with carbon cellulose.

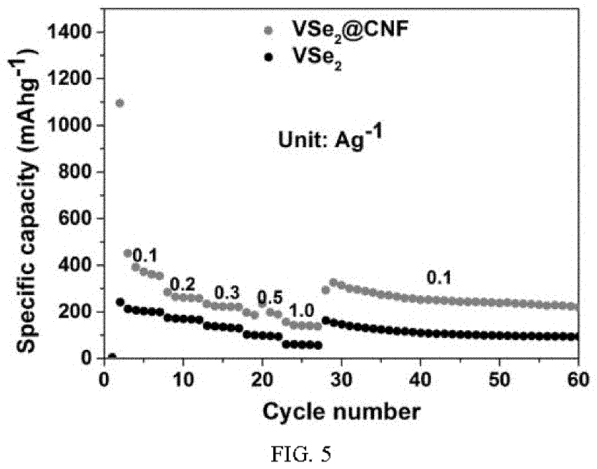

FIG. 5 is a graph showing charge-discharge rate performances of button batteries made of a vanadium selenide/carbon cellulose composite prepared in example 1 and a pure layered VSe₂ material prepared in comparative example 1 respectively under the current density of 100˜1000 mAg⁻¹. It can be seen from FIG. 5 that the vanadium selenide/carbon cellulose composite prepared in example 1 has reversible capacities of 258.3, 214.2, 190.3, 160.7 [symbol] 126.1 mAhg⁻¹ under the current density of 100, 200, 300, 500 and 1000 mAg⁻¹. However, the pure layered VSe₂ material has the capacities of 196.8, 164.9, 130.2, 93.8 and 55.8 mAhg⁻¹ under the same rate current density. According to the above results, the capacity of the material under the large current density can be effectively improved after VSe₂ is coated with carbon cellulose.

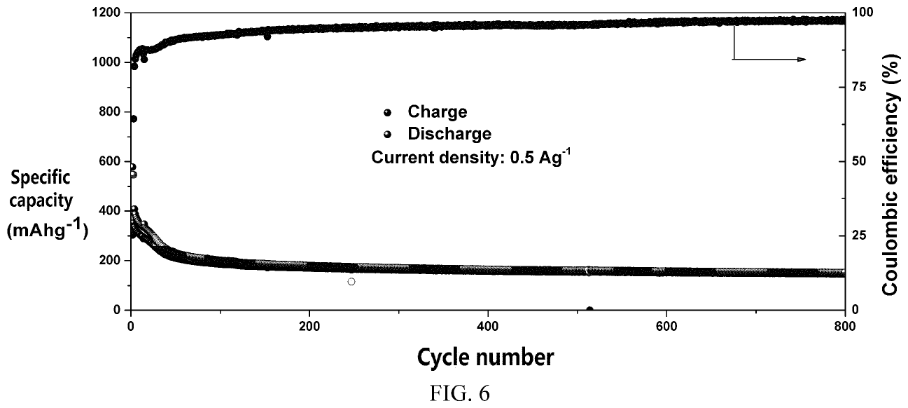

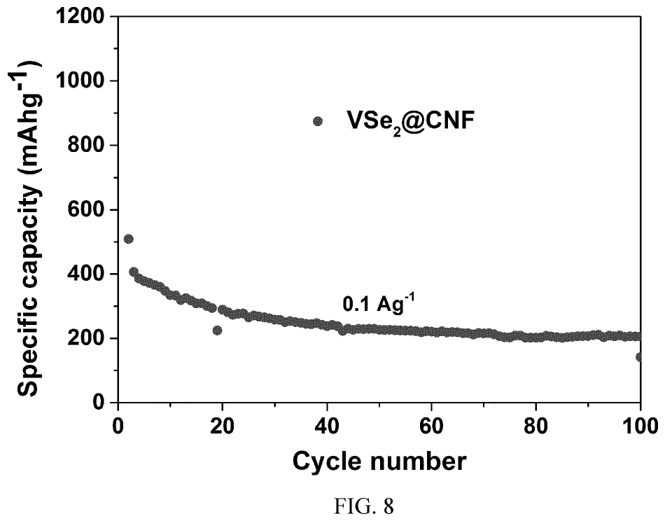

FIG. 6 is a graph showing charge-discharge rate long-cycle performances of a button battery made of a vanadium selenide/carbon cellulose composite prepared in example 1 under the current density of 500 mAg⁻¹. It can be seen from FIG. 8 that the capability of the vanadium selenide/carbon cellulose composite prepared in example 1 after 800 cycles is maintained to 151.4 mAhg⁻¹. Accordingly, the long-cycle stability and structural stability of the material can be effectively improved after VSe₂ is coated with carbon cellulose.

### Example 2

1, Vanadium dioxide and selenium dioxide were weighed and dissolved into an N-methylpyrrolidone solvent so as to be prepared into a solution having a concentration of 1.5 mol/L, and the above solution was stirred is for 0.5 h to obtain a taupe solution;

2, formic acid was added into the salt solution obtained in step 1) and continued to be stirred for 0.5 h to obtain a mixed solution;

3, the mixed solution obtained in step 2) was transferred into a high-pressure hydrothermal reactor with teflon lining, and heat preservation was carried out for 24 h at 200° C.;

4, the solution obtained in step 3) was cooled and then repeatedly centrifuged with deionized water and absolute alcohol at a rate of 10000 r/m, and the solution was discarded to obtain a black precipitate;

5, the black precipitate obtained in step 4) was dried for 24 h at 80° C. to obtain black powder;

6, 10 g of qualitative filter paper was weighed and cut into pieces to be put in a wall-breaking machine, 2000 mL of deionized water was added, and homogenization was carried out for 30 min, and homogenization was repeated for three times, so as to obtain a 1% carbon cellulose aqueous solution;

7, 1.0 g of black powder obtained in step 5) and 500 mL of solution obtained in step 6) were weighed, and stirred for 24 h;

8, the mixed solution obtained in step 7) was frozen with liquid nitrogen at −180° C. for 5 min to obtain a yellow green frozen solid;

9, freeze drying was carried out on the frozen solid obtained in step 8) for 72 h in vacuum to obtain fluffy aerogel; and

10, the aerogel obtained in step 9) was ground, a temperature was raised from 25° C. to 550° C. at a rate of 5° C./min at an inert atmosphere and heat preservation was carried out for 2.0 h, subsequently, the temperature was raised to 950° C. at a rate of 5° C./min and heat preservation was carried out for 1.0 h, and the above aerogel was naturally cooled to room temperature, so as to obtain the vanadium selenide/carbon cellulose composite.

The vanadium selenide/carbon cellulose composite obtained in this example 2 in a ratio of 7.5:1.5:1.5, acetylene black and binder PVDF were dissolved into N-methylpyrrolidone and stirred. The obtained slurry is coated on copper foil, and dried in vacuum for 12 h, so as to obtain a positive electrode plate. Then, the battery was assembled in a glove box filled with argon, the positive electrode was the vanadium selenide/carbon cellulose composite, a negative electrode was a potassium plate, a diaphragm was glass fiber, and an electrolyte was KPF₆. The electrochemical performance test was carried out between 0.01˜3.0V at 25° C. The results show that the vanadium selenide/carbon cellulose composite prepared in example 2 has excellent rate performance and cycle stability.

### Example 3

1, Vanadium dioxide and selenium dioxide were weighed and dissolved into an N-methylpyrrolidone solvent so as to be prepared into a solution having a concentration of 1.5 mol/L, and the above solution was stirred is for 0.5 h to obtain a taupe solution;

2, formic acid was added into the salt solution obtained in step 1) and continued to be stirred for 0.5 h to obtain a mixed solution;

3, the mixed solution obtained in step 2) was transferred into a high-pressure hydrothermal reactor with teflon lining, and carrying out heat preservation for 24 h at 200° C.;

4, the solution obtained in step 3) was cooled and then repeatedly centrifuged with deionized water and absolute alcohol at a rate of 10000 r/m, and the solution was discarded to obtain a black precipitate;

5, the black precipitate obtained in step 4) was dried for 24 h at 80° C. to obtain black powder;

6, 10 g of qualitative filter paper was weighed and cut into pieces to be put in a wall-breaking machine. 500 mL of deionized water was added, and homogenization was carried out for 30 min, and homogenization was repeated for three times to obtain a 1% carbon cellulose aqueous solution;

7, 1.0 g of black powder obtained in step 5) and 500 mL of solution obtained in step 6) were weighed, and stirred for 24 h;

8, the mixed solution obtained in step 7) was frozen with liquid nitrogen at −160° C. for 10 min to obtain a yellow green frozen solid;

9, freeze drying was carried out on the frozen solid obtained in step 8) for 96 h in vacuum to obtain fluffy aerogel; and

10, the aerogel obtained in step 9) was ground, a temperature was raised from 25° C. to 600° C. at a rate of 5° C./min at an inert atmosphere and heat preservation was carried out for 1.0 h, subsequently, the temperature was raised to 1000° C. at a rate of 5° C./min and heat preservation was carried out for 0.5 h, and the above aerogel was naturally cooled to room temperature, so as to obtain the vanadium selenide/carbon cellulose composite.

The vanadium selenide/carbon cellulose composite obtained in this example 3 in a ratio of 7.5:1.5:1.5, acetylene black and binder PVDF were dissolved into N-methylpyrrolidone and stirred. The obtained slurry is coated on copper foil, and dried in vacuum for 12 h, so as to obtain a positive electrode plate. Then, the battery was assembled in a glove box filled with argon, the positive electrode was the vanadium selenide/carbon cellulose composite, a negative electrode was a potassium plate, a diaphragm was glass fiber, and an electrolyte was KPF₆. The electrochemical performance test was carried out between 0.01˜3.0 V at 25° C. The results show that the vanadium selenide/carbon cellulose composite prepared in example 3 has excellent rate performance and cycle stability.

### Example 4

1, Vanadium dioxide and selenium dioxide were weighed and dissolved into an N-methylpyrrolidone solvent so as to be prepared into a solution having a concentration of 1.5 mol/L, and the above solution was stirred is for 0.5 h to obtain a taupe solution;

2, formic acid was added into the salt solution obtained in step 1) and continued to be stirred for 0.5 h to obtain a mixed solution;

3, the mixed solution obtained in step 2) was transferred into a high-pressure hydrothermal reactor with Teflon lining, and carrying out heat preservation for 30 h at 180° C.;

4, the solution obtained in step 3) was cooled and then repeatedly centrifuged with deionized water and absolute alcohol at a rate of 10000 r/m, and the solution was discarded to obtain a black precipitate;

5, the black precipitate obtained in step 4) was dried for 24 h at 80° C. to obtain black powder;

6, 10 g of qualitative filter paper was weighed and cut into pieces to be put in a wall-breaking machine, 1000 mL of deionized water was added, and homogenization was carried out for 15 min, and homogenization was repeated for three times, so as to obtain a 1% carbon cellulose aqueous solution;

7, 1.0 g of black powder obtained in step 5) and 500 mL of solution obtained in step 6) were weighed, and stirred for 18 h;

8, the mixed solution obtained in step 7) was frozen with liquid nitrogen at −200° C. for 10 min to obtain a yellow green frozen solid;

9, freeze drying was carried out on the frozen solid obtained in step 8) for 96 h in vacuum to obtain fluffy aerogel; and

10, the aerogel obtained in step 9) was ground, a temperature was raised from 25° C. to 500° C. at a rate of 5° C./min at an inert atmosphere and heat preservation was carried out for 1.5 h, subsequently, the temperature was raised to 1000° C. at a rate of 5° C./min and heat preservation was carried out for 0.5 h, and the above aerogel was naturally cooled to room temperature, so as to obtain the vanadium selenide/carbon cellulose composite.

The vanadium selenide/carbon cellulose composite obtained in this example 4 in a ratio of 7.5:1.5:1.5, acetylene black and binder PVDF were dissolved into N-methylpyrrolidone and stirred. The obtained slurry is coated on copper foil, and dried in vacuum for 12 h, so as to obtain a positive electrode plate. Then, the battery was assembled in a glove box filled with argon, the positive electrode was the vanadium selenide/carbon cellulose composite, a negative electrode was a potassium plate, a diaphragm was glass fiber, and an electrolyte was KPF₆. The electrochemical performance test was carried out between 0.01˜3.0 V at 25° C. The results show that the vanadium selenide/carbon cellulose composite prepared in example 4 has excellent rate performance and cycle stability

### Example 5

1, Vanadium dioxide and selenium dioxide were weighed and dissolved into an N-methylpyrrolidone solvent so as to be prepared into a solution having a concentration of 1.0 mol/L, and the above solution was stirred is for 0.5 h to obtain a taupe solution;

2, formic acid was added into the salt solution obtained in step 1) and continued to be stirred for 0.5 h to obtain a mixed solution;

3, the mixed solution obtained in step 2) was transferred into a high-pressure hydrothermal reactor with teflon lining, and heat preservation was carried out for 24 h at 200° C.;

4, the solution obtained in step 3) was cooled and then repeatedly centrifuged with deionized water and absolute alcohol at a rate of 8000 r/m, and the solution was discarded to obtain a black precipitate;

5, the black precipitate obtained in step 4) was dried for 24 h at 80° C. to obtain black powder;

6, 10 g of qualitative filter paper was weighed and cut into pieces to be put in a wall-breaking machine, 1000 mL of deionized water was added, and homogenization was carried out for 20 min, and homogenization was repeated for three times, so as to obtain a 1% carbon cellulose aqueous solution;

7, 1.0 g of black powder obtained in step 5) and 500 mL of solution obtained in step 6) were weighed, and stirred for 18 h;

8, the mixed solution obtained in step 7) was frozen with liquid nitrogen at −200° C. for 15 min to obtain a yellow green frozen solid;

9, freeze drying was carried out on the frozen solid obtained in step 8) for 72 h in vacuum to obtain fluffy aerogel; and

10, the aerogel obtained in step 9) was ground, a temperature was raised from 25° C. to 550° C. at a rate of 5° C./min at an inert atmosphere and heat preservation was carried out for 1.2 h, subsequently, the temperature was raised to 950° C. at a rate of 5° C./min and heat preservation was carried out for 1.0 h, and the above aerogel was naturally cooled to room temperature, so as to obtain the vanadium selenide/carbon cellulose composite.

The vanadium selenide/carbon cellulose composite obtained in this example 4 in a ratio of 7.5:1.5:1.5, acetylene black and binder PVDF were dissolved into N-methylpyrrolidone and stirred. The obtained slurry is coated on copper foil, and dried in vacuum for 12 h, so as to obtain a positive electrode plate. Then, the battery was assembled in a glove box filled with argon, the positive electrode was the vanadium selenide/carbon cellulose composite, a negative electrode was a potassium plate, a diaphragm was glass fiber, and an electrolyte was KPF₆. The electrochemical performance test was carried out between 0.01˜3.0 V at 25° C. The results show that the vanadium selenide/carbon cellulose composite prepared in example 4 has excellent rate performance and cycle stability.

We claim:

1. A preparation method of a vanadium selenide/carbon cellulose composite, comprising the following steps:
1) weighing Vanadium dioxide and selenium dioxide, dissolving into water or an organic solvent so as to be prepared into a solution having a concentration of 0.5˜2 mol/L, and stirring for 0.5 h to obtain a taupe solution;
2) adding an organic acid into the salt solution obtained in step 1), and continuing to stir for 0.5 h to obtain a mixed solution;
3) transferring the mixed solution obtained in step 2) into a high-pressure hydrothermal reactor with teflon lining, and carrying out heat preservation for 15˜30 h at 150˜220° C.;
4) cooling the solution obtained in step 3), then repeatedly centrifuging with deionized water and absolute alcohol at a rate of 5000˜10000 r/m, and discarding the solution to obtain a black precipitate;
5) drying the black precipitate obtained in step 4) for 12˜24 h at 50˜120° C. to obtain black powder,
6) weighing 10 g of qualitative filter paper, cutting into pieces to be put in a wall-breaking machine, adding 500˜2000 mL of deionized water, homogenizing for 15˜60 min, and repeating homogenization for three times, so as to obtain a 0.5˜2% carbon cellulose aqueous solution;
7) weighing 1.0 g of black powder obtained in step 5) and 500 mL of solution obtained in step 6), and stirring for 12˜24 h;
8) freezing the mixed solution obtained in step 7) with liquid nitrogen at −100˜−200° C. for 5˜20 min to obtain a yellow green frozen solid;
9) carrying out freeze drying on the frozen solid obtained in step 8) for 48˜96 h in vacuum to obtain fluffy aerogel; and
10) grinding the aerogel obtained in step 9), raising a temperature from 25° C. to 50>600° C. at a rate of 1˜5° C./min at an inert atmosphere and carrying out heat preservation for 0.5˜2 h, subsequently, raising a temperature to 800° C.˜1000° C. at a rate of 1˜5° C./min and carrying out heat preservation for 0.5˜2 h, and naturally cooling to room temperature to obtain the vanadium selenide/carbon cellulose composite;
wherein, the vanadium selenide/carbon cellulose composite is prepared by the above method, and used as a negative electrode material of a potassium ion battery, the vanadium selenide/carbon cellulose composite.

2. The preparation method of a vanadium selenide/carbon cellulose composite according to claim 1, wherein in the vanadium selenide/carbon cellulose composite, the mass percentage of VSe₂ is 50˜60%, and the mass percentage of carbon quantum dots/carbon is 40˜50%.

3. The preparation method of a vanadium selenide/carbon cellulose composite according to claim 1, wherein in step 1), the vanadium oxide is vanadium dioxide, the selenium oxide is selenium dioxide, and the solvent is one of deionized water or N-methylpyrrolidone.

4. The preparation method of a vanadium selenide/carbon cellulose composite according to claim 1, wherein in step 2), the organic acid is formic acid.

5. The preparation method of a vanadium selenide/carbon cellulose composite according to claim 1, wherein in step 3), the heat preservation temperature is preferably controlled to 180˜220° C., and the heat preservation time is preferably controlled to 20˜28 h.

6. The preparation method of a vanadium selenide/carbon cellulose composite according to claim 1, wherein in step 4), the centrifugation rate is preferably controlled to 8000˜10000 r/min.

7. The preparation method of a vanadium selenide/carbon cellulose composite according to claim 1, wherein in step 5), the drying temperature is preferably controlled to 80˜100° C., and the heat preservation time is controlled to 18˜24 h.

8. The preparation method of a vanadium selenide/carbon cellulose composite according to claim 1, wherein in step 6), the concentration of the aqueous solution is preferably controlled to 1%.

9. The preparation method of a vanadium selenide/carbon cellulose composite according to claim 1, wherein in step 7), the stirring time is preferably controlled to 18˜24 h.

10. The preparation method of a vanadium selenide/carbon cellulose composite according to claim 1, wherein in step 8), the freezing temperature is preferably controlled to −160˜200° C., and the freezing time is preferably controlled to 10˜15 min.

11. THE preparation method of a vanadium selenide/carbon cellulose composite according to claim 1, wherein in step 9), the freeze drying time is preferably controlled to 72˜96 h.

12. The preparation method of a vanadium selenide/carbon cellulose composite according to claim 1, wherein in step 10), the inert gas atmosphere is one or more of nitrogen or argon, preferably argon, the temperature rising rate is preferably 5° C./min, a first heat preservation temperature is preferably 500˜600° C., the heat preservation time is preferably 1.5˜2 h, a second heat preservation temperature is preferably 900˜1000° C., and the heat preservation time is preferably 0.5˜1 h.
